(19) United States
(12) Patent Application Publication
(10) Pub. No.: US 2015/0222717 A1
(43) Pub. Date: Aug. 6, 2015

(54) APPARATUS AND METHOD FOR UPDATING IP GEOGRAPHIC INFORMATION

(71) Applicant: TENCENT TECHNOLOGY (SHENZHEN) COMPANY LIMITED, Shenzhen (CN)

(72) Inventors: YUHUANG LI, Shenzhen (CN); PENG HE, Shenzhen (CN); CHUAN CHEN, Shenzhen (CN)

(73) Assignee: TENCENT TECHNOLOGY (SHENZHEN) COMPANY LIMITED

(21) Appl. No.: 14/688,213

(22) Filed: Apr. 16, 2015

Related U.S. Application Data
(63) Continuation of application No. PCT/CN2013/084359, filed on Sep. 26, 2013.

(30) Foreign Application Priority Data
Oct. 16, 2012 (CN) 2012-10392287.8

(51) Int. Cl. H04L 29/08; H04L 12/26

(52) U.S. Cl. CPC H04L 67/18; H04L 43/04

(57) ABSTRACT

The present disclosure discloses a method and apparatus for updating IP geographic information. Initial geographic information of a new IP is determined according to a user log, and an initial geographic information table of all new IPs is established. Segment aggregation processing is performed on the initial geographic information table to obtain a segment IP geographic information table. Boundary demarcation processing is performed on the segment IP geographic information table to obtain an accurate geographic information table of the new IPs. An IP library is updated according to the accurate geographic information table. By using the disclosed method and apparatus of the present disclosure, geographic information corresponding to the new IP can be positioned accurately, and the IP library can be updated timely.

### CROSS-REFERENCES TO RELATED APPLICATIONS

This application is a continuation of PCT Application No. PCT/CN2013/084359, filed on Sep. 26, 2013, which claims priority to Chinese Patent Application No. CN 201210392287.8, filed on Oct. 16, 2012, the entire contents of all of which are incorporated herein by reference.

### FIELD OF THE TECHNOLOGY

The present disclosure relates to Internet technology, and in particular, relates to an apparatus and a method for updating IP (internet protocol) geographic information.

### BACKGROUND OF THE DISCLOSURE

The rapid development of the Internet may cause a serious shortage of IP resources. Each year, new IP resources are delivered to the market regularly or irregularly.

After a new IP resource is delivered to the market, if an IP geographic information based system or device cannot timely position city-level geographic information corresponding to the new IP, a series of problems may be caused. For example, login tips may indicate occurring of inaccurate geographic information, inaccurate panel weather information, inaccurate setting of default city in the map (or no default city setting), and the like. This seriously affects service-providing capabilities of the system or the device, reduces user experiences, and causes increased user complaints.

Therefore, there is a need to solve technical problems in the Internet technology to provide methods and apparatus/devices for accurately and timely positioning geographic information corresponding to new IP(s).

### SUMMARY

In view of the above, methods and apparatus are provided herein for updating IP geographic information. Geographic information corresponding to a new IP can then be accurately positioned, and an IP library can be updated timely. In order to achieve the foregoing objective, solutions of the embodiments of the present invention are implemented as follows.

An embodiment of the present invention provides a method for updating IP geographic information, including: determining initial geographic information of a new IP according to a user log, and establishing an initial geographic information table of all new IPs; performing a segment aggregation processing on the initial geographic information table to obtain a segment IP geographic information table; performing a boundary demarcation processing on the segment IP geographic information table to obtain an accurate geographic information table of the new IPs; and updating an IP library according to the accurate geographic information table of the new IPs.

An embodiment of the present invention further provides an apparatus for updating IP geographic information, including: an initial information determining module, an adoption processing module, a boundary searching module, and an updating module. The initial information determining module is configured to determine initial geographic information of a new IP according to a user log, and establish an initial geographic information table of all new IPs. The adoption processing module is configured to perform a segment aggregation processing on the initial geographic information table established by the initial information determining module, to obtain a segment IP geographic information table. The boundary searching module is configured to perform a boundary demarcation processing on the segment IP geographic information table to obtain an accurate geographic information table of the new IPs. The updating module is configured to update an IP library according to the accurate geographic information table of the new IPs.

In the disclosed apparatus and the method for updating IP geographic information, initial geographic information of a new IP is determined according to a user log, and an initial geographic information table of all new IPs is established. Segment aggregation processing is performed on the initial geographic information table to obtain a segment IP geographic information table. Boundary demarcation processing is performed on the segment IP geographic information table to obtain an accurate geographic information table of the new IPs. An IP library is updated according to the accurate geographic information table. In this way, geographic information corresponding to the new IP can be positioned accurately, and the IP library can be updated timely.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure. The embodiments of the present invention are described below with reference to the accompanying drawings. In these accompanying drawings:

FIG. 1 is a schematic flowchart of a method for updating IP geographic information according to an exemplary embodiment of the present invention;

FIG. 2 is a schematic flowchart of an exemplary step in updating IP geographic information according to an exemplary embodiment of the present invention;

FIG. 3 is a schematic flowchart of another exemplary step in updating IP geographic information according to an exemplary embodiment of the present invention;

FIG. 4 is a schematic structural diagram of an exemplary apparatus for updating IP geographic information according to an embodiment of the present invention; and

FIG. 5 illustrates an exemplary computing device consistent with the disclosed embodiments.

### DESCRIPTION OF EMBODIMENTS

In embodiments of the present invention, a new-IP updating apparatus determines initial geographic information of a new IP according to a user log, and establishes an initial geographic information table of all new IPs; performs segment aggregation processing on the initial geographic information table to obtain a segment IP geographic information table; performs boundary demarcation processing on the segment IP geographic information table to obtain an accurate geographic information table of the new IPs; and updates an IP library according to the accurate geographic information table.

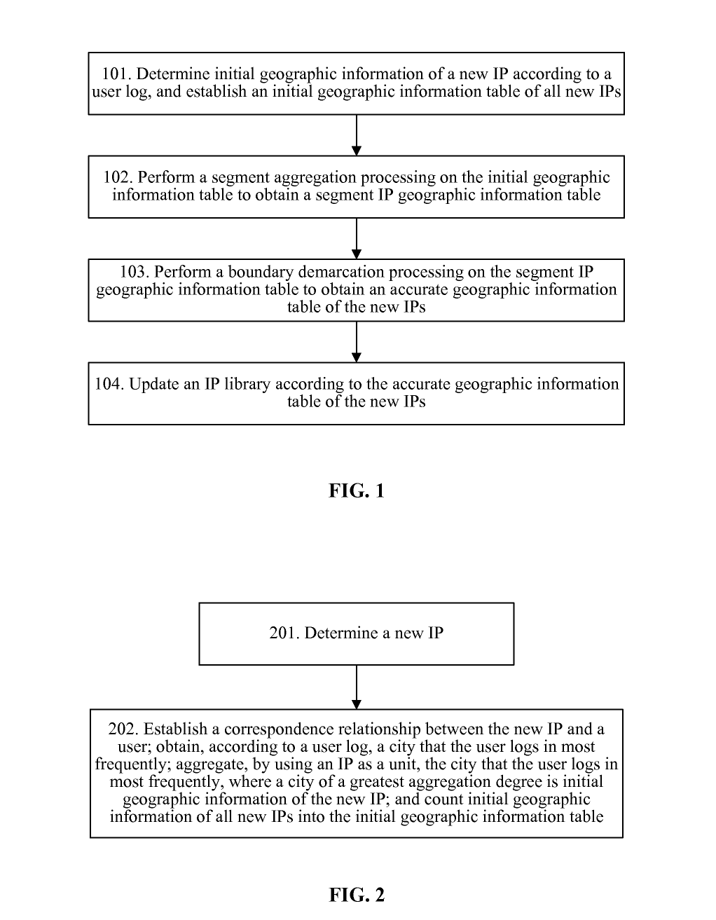

The following further describes the present disclosure in detail by using the accompanying drawings and the specific embodiments. An embodiment of the present invention implements a method for updating IP geographic information. As shown in FIG. 1, the method includes the following exemplary steps.

Step 101: includes determining initial geographic information of a new IP according to a user log, and establishes an initial geographic information table of all new IPs.

Specifically, as shown in FIG. 2, the exemplary step 101 includes: Step 201 to determine the new IP. For example, an IP in a day log of the user is compared with an IP in an IP library. When the IP in the user log is not in the IP library, a segment IP containing the IP is not in the IP library, and the IP and the segment IP containing the IP have a large quantity of user logins, then it is determined that the IP in the user log is a new IP. As used herein, a large quantity of user logins refers to that, more than about 30% of point IPs of the segment IP have user logins. For example, if a segment IP has about 256 point IPs, and about 77 point IPs have user logins (which is more than 30% of the total 256 point IPs of this segment IP), it is then considered that there are a large quantity of user logins.

In this exemplary step, the IP refers to an IPv4 resource, the IP library refers to a database configured to store IPs used by users to log in, and the user log may be a log of a large quantity of user logins.

Step 202: establishes a correspondence relationship between the new IP and a user; obtains, according to the user log, a city that the user logs in most frequently; aggregates, by using an IP as a unit, the city that the user logs in most frequently, where a city of a greatest aggregation degree is the initial geographic information of the new IP; and counts initial geographic information of all new IPs into the initial geographic information table.

The obtaining of, according to the user log, a city that the user logs in most frequently includes: counting, in the user log, a city corresponding to an IP that has been logged in and used by the user, and determining, within a preset time limit, the city that the user logs in most frequently. In one embodiment, the preset time may be about 30 days or any other suitable time period. For example, it may be assumed that a user A has logged in about 45 times in the past 30 days, among which a login IP for 43 times is a known IP, and the 43 times of login behaviors are referred to as valid login. A city that each IP of valid login is located and that satisfies the following two conditions is computed, and a city satisfying the conditions is a city that the user A has logged in most frequently in the past 30 days: 1) having the most login times; and 2) login times/valid login times≧⅓, in this example, the login times need to satisfy that login times≧15 among the 45 times.

Further, if there are two cities satisfying the foregoing two conditions, a city having a most recent login time is selected as the most frequent login city. For example, the user A has logged in 15 times in city of Shenzhen in recent 30 days, and also has logged in 15 times in city of Guangzhou, where a most recent login time of the city of Shenzhen is the day before yesterday, and a most recent login time of the city of Guangzhou is a week ago, and then the city that the user A has logged in most frequently in the past 30 days is the city of Shenzhen.

Step 102: includes performing a segment aggregation processing on the initial geographic information table to obtain a segment IP geographic information table.

Specifically, initial geographic information of the new IPs in the initial geographic information table are segmented by using K-means algorithm (e.g., having a modulus K); a geographic information aggregation degree of each segment IP after segmentation is computed; for each segment IP, geographic information having a greatest aggregation degree is selected as geographic information of the segment IP, where the geographic information has an aggregation degree higher than a threshold P0 and a number of occurrences higher than threshold N0; and the geographic information of each segment IP is counted into the segment IP geographic information table.

The value of P0 is determined by a balance between the accuracy and the coverage, and the following conditions need to be satisfied: 1) accuracy≧95%; 2) coverage≧90%; and 3) a fitting process: for example, according to a point 0.001, a score of each P0 under the foregoing two conditions is computed, where the score=accuracy*coverage, and the P0 value having a highest score is selected as the threshold P0 value.

The number of occurrences refers to the number of times, for example, for an IP segment, geographic information being the city of Shenzhen appears about 100 times, and then number of occurrences that geographic information of the IP segment is Shenzhen is 100.

A value of number of occurrences NO is related to the length of an IP segment, the accuracy, and the coverage, and a computing method of NO is similar to that of P0, and needs to satisfy the following conditions of linear optimization: 1) NO/length of the IP segment>30%; 2) accuracy>=95%; 3) coverage>=90%; and 4) a fitting process: for example, according to a step length of 5, a score of each number of occurrences N0 under the foregoing three conditions is computed, where the score=accuracy*coverage, and an N0 value having a highest score is selected as threshold N0.

The computed geographic information aggregation degree of each segment IP after segmentation refers to a proportion accounted for in the segment IP by point IPs having same geographic information. For example, in a case there are about 220 point IPs having initial geographic information in a segment IP, and among them, geographic information of about 180 point IPs is Shenzhen City (Guangdong Province), then an aggregation degree of the segment IP of Shenzhen City (Guangdong Province) is about 82% (=180/220).

This exemplary step further includes: linking adjacent segment IPs having consistent geographic information to form a new segment IP having geographic information, and counting the geographic information of the new segment IP into the segment IP geographic information table directly. For example, in a case that a segment IP: 1.1.1.0-1.1.1.255 and a segment IP: 1.1.2.0-1.1.2.255 may be adjacent both with geographic information of Shenzhen City (Guangdong Province), a new segment IP: 1.1.1.0-1.1.2.255 may then be formed having geographic information of Shenzhen City (Guangdong Province).

This exemplary step further includes: determining geographic information of a segment IP whose geographic information cannot be determined by using a geographic information aggregation degree, according to a front segment IP and a rear segment IP that have consistent geographic information.

Specifically, the number of spaced segments between the front segment IP and the rear segment IP is less than a threshold M0, and geographic information is consistent. When in a spaced segment IP, there are more than a threshold number N1 of point IPs whose initial geographic information is consistent with geographic information of the front segment IP and the rear segment IP, the initial geographic information is used as geographic information of the spaced segment IP. For example, geographic information of a segment IP: 1.1.1.0-1.1.1.255 is Shenzhen City (Guangdong Province), geographic information of a segment IP: 1.1.3.0-1.1.3.255 is also Shenzhen City (Guangdong Province), and in a segment IP 1.1.2.0-1.1.2.255 spaced in between, there are 60 point IPs whose initial geographic information is Shenzhen City (Guangdong Province). When the number 60 (of point IPs) satisfies (e.g., greater than and/or equal to) the threshold N1, it is determined that geographic information of the segment IP: 1.1.2.0-1.1.2.255 is Shenzhen City (Guangdong Province).

Step 103: includes performing a boundary demarcation processing on the segment IP geographic information table to obtain an accurate geographic information table of the new IPs.

IP geographic information is determined according to the K-means algorithm on a rear segment. However, in fact, a boundary of IPs having same IP geographic information certainly does not fall on a boundary generated after the K-means each time, may fall inside a segment IP and may also fall outside the segment IP. If the boundary is in the segment IP, adoption errors may occur to a part of the geographic information of IPs. For example, all geographic information of 1.1.1.0-1.1.1.200 is Shenzhen City (Guangdong Province), while geographic information of 1.1.1.201-1.1.1.255 is Dongguan city (Guangdong Province). If adoption is performed according to a modulus 256 (e.g., after 1.1.1.255), Shenzhen City (Guangdong Province) is adopted as geography of the segment, which causes erroneous adoption of geographic information for 55 IPs. And if the boundary is outside the segment IP, geographic information adopted for the new IP may have incomplete coverage. Therefore, inward-boundary-searching logic and outward-boundary-searching logic are designed for a boundary searching module, so as to solve the foregoing problems.

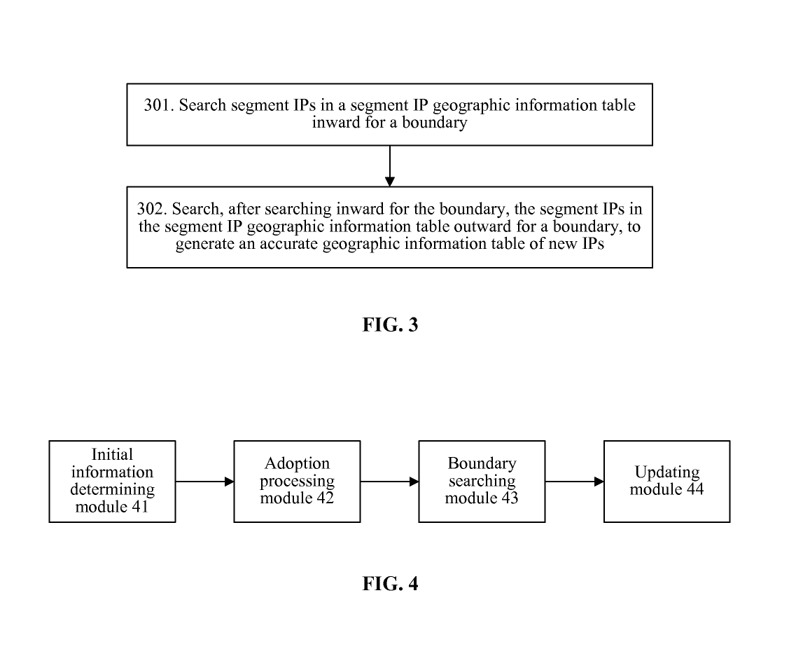

Specifically, as shown in FIG. 3, this exemplary step includes: Step 301 to search segment IPs in the segment IP geographic information table inward for a boundary.

For each segment IP in the segment IP geographic information table, starting from a boundary of a segment IP, point IPs whose initial geographic information in continuous D0 days is all inconsistent or which have no initial geographic information are searched inward until a convergence, where a convergence point IP is an accurate boundary of a corresponding segment IP, and a value of the D0 ranges from 0 to 100.

The boundary of the segment IP is divided into an upper limit boundary and a lower limit boundary. Using the upper limit boundary as an example, point IPs whose initial geographic information in the continuous D0 days is all inconsistent or which have no initial geographic information are searched for downward one by one until the convergence, where a convergence point IP is an accurate upper limit boundary of the corresponding segment IP.

Step 302: includes searching, after searching inward for the boundary, the segment IPs in the segment IP geographic information table outward for a boundary, to generate the accurate geographic information table of the new IPs.

Specifically, for each segment IP in the segment IP geographic information table, starting from a boundary of a segment IP, point IPs whose initial geographic information in continuous D1 days is all consistent are searched for one by one until the convergence, where a convergence point IP-1 is an accurate boundary of a corresponding segment IP, and the segment IP geographic information table is arranged according to the accurate boundary of the segment IP, to generate the accurate geographic information table of the new IPs; and a value of the D1 ranges from 0 to 256.

The boundary of the segment IP is divided into an upper limit boundary and a lower limit boundary. Using the upper limit boundary as an example, point IPs whose initial geographic information in the continuous D1 days is all consistent, are searched for upward one by one until the convergence, where a convergence point IP-1 is an accurate upper limit boundary of the corresponding segment IP.

Step 104: includes updating an IP library according to the accurate geographic information table of the new IPs.

Specially, the accurate geographic information table of the new IPs is converted into an IP library standard interface, an adoption credit score of each new IP in the accurate geographic information table of the new IPs is computed, and the geographic information table of the new IP is connected to IP library processing logic, to participate in daily update processing of the IP library.

The adoption credit score of the new IP uses a base (or benchmark) score plus parameter logic, where the base score may be 5, and the parameter logic may be a multiplication of the geographic information aggregation degree of each segment IP and the number of occurrences. Then, a final credit score may be obtained. For example, an aggregation degree that geographic information of a new IP in a segment IP is Shenzhen may be 70%, a number of occurrences may be 50, and then a adoption credit score of the new IP=5+50*70%=8.5 (scores). Herein, a full score is 10 (scores). A score greater than 10 scores is recorded as 10 scores.

In order to implement the foregoing method, an embodiment of the present invention further provides an apparatus for updating IP geographic information. As shown in FIG. 4, the apparatus includes: an initial information determining module 41, an adoption processing module 42, a boundary searching module 43, and an updating module 44.

The initial information determining module 41 is configured to determine initial geographic information of a new IP according to a user log, and establish an initial geographic information table of all new IPs. The adoption processing module 42 is configured to perform segment aggregation processing on the initial geographic information table established by the initial information determining module 41, to obtain a segment IP geographic information table. The boundary searching module 43 is configured to perform boundary demarcation processing on the segment IP geographic information table to obtain an accurate geographic information table of the new IPs. The updating module 44 is configured to update an IP library according to the accurate geographic information table of the new IPs.

The initial information determining module 41 is specifically configured to determine the new IP; to establish a correspondence relationship between the new IP and a user; to obtain, according to the user log, a city that the user logs in most frequently; to aggregate, by using an IP as a unit, the city that the user logs in most frequently, where a city of a greatest aggregation degree is the initial geographic information of the new IP; and to count initial geographic information of all new IPs into the initial geographic information table.

The adoption processing module 42 is specifically configured to segment, by using K-means algorithm, initial geographic information of the new IPs in the initial geographic information table; to compute a geographic information aggregation degree of each segment IP after segmentation; to select, for each segment IP, geographic information having a greatest aggregation degree as geographic information of the segment IP, where the geographic information has an aggregation degree higher than a threshold P0 and a number of occurrences higher than threshold N0; and to count the geographic information of each segment IP into the segment IP geographic information table.

The adoption processing module 42 is further configured to link adjacent segment IPs having consistent geographic information to form a new segment IP having geographic information, and to count the geographic information of the new segment IP into the segment IP geographic information table directly.

The adoption processing module 42 is further configured to determine geographic information of a segment IP whose geographic information cannot be determined by using a geographic information aggregation degree, according to a front segment IP and a rear segment IP that have consistent geographic information.

The boundary searching module 43 is specifically configured to search segment IPs in the segment IP geographic information table inward for a boundary; and to search, after searching inward for the boundary, the segment IPs in the segment IP geographic information table outward for a boundary, to generate the accurate geographic information table of the new IPs.

The updating module 44 is specifically configured to convert the accurate geographic information table of the new IP into an IP library standard interface, to compute an adoption credit score of each new IP in the accurate geographic information table of the new IP, and to connect the accurate geographic information table of the new IP to IP library processing logic, to participate in daily update processing of the IP library.

When the method for updating IP geographic information described in the embodiments of the present invention is implemented in a form of a software functional module and is sold or used as an independent product, it may also be stored in a computer-readable storage medium. Based on such an understanding, in technical solutions of the embodiments of the present invention, essentially, a part contributing to the prior art may be implemented in a form of a software product. The computer software product is stored in a storage medium, and includes several instructions for instructing a computer device (which may be a personal computer, a server, a network device, or the like) to perform all or a part of the method described in the embodiments of the present invention. However, the foregoing storage medium includes: any medium that can store program code, such as a USB flash drive, a removable hard disk, a read-only memory (ROM), a random access memory (RAM), a magnetic disk, or an optical disk. In this way, the embodiments of the present invention are not limited to a combination of any particular hardware and software.

Correspondingly, an embodiment of the present invention further provides a computer storage medium, which stores a computer program, where the computer program is used for executing the method for updating IP geographic information in the embodiments of the present invention.

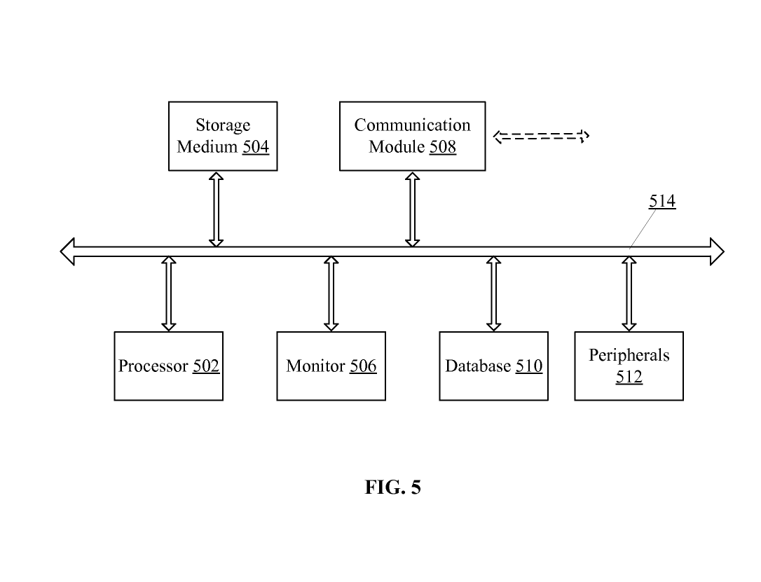

For example, FIG. 5 illustrates an exemplary computing device capable of implementing the disclosed methods, consistent with the disclosed embodiments. The exemplary computing device may include the disclosed apparatus.

As shown in FIG. 5, the exemplary computing device 500 may include a processor 502, a storage medium 504, a monitor 506, a communication module 508, a database 510, peripherals 512, and one or more bus 514 to couple the devices together. Certain devices may be omitted and other devices may be included.

Processor 502 may include any appropriate processor or processors. Further, processor 502 may include multiple cores for multi-thread or parallel processing. The processor 502 may be used to run computer program(s) stored in the storage medium 504. Storage medium 504 may include memory modules, such as ROM, RAM, and flash memory modules, and mass storages, such as CD-ROM, U-disk, removable hard disk, etc. Storage medium 504 may store computer programs for implementing various disclosed methods (e.g., methods for updating IP geographic information), when executed by processor 502. In one embodiment, storage medium 504 may be a non-transitory computer-readable storage medium having a computer program stored thereon, when being executed, to cause the computer to implement the disclosed methods.

Further, peripherals 512 may include I/O devices such as keyboard and mouse, and communication module 508 may include network devices for establishing connections, e.g., through a communication network such as the Internet. Database 510 may include one or more databases for storing certain data and for performing certain operations on the stored data, such as webpage browsing, database searching, etc.

In various embodiments, the computing device may be a personal computer (PC), a work station computer, a server computer, a hand-held computing device (tablet), a smart phone or mobile phone, a car-carrying device, or any other suitable computing device.

As such, an IP library is updated according to an accurate geographic information table of a new IP. Geographic information corresponding to the new IP can be positioned accurately, and the IP library can be updated timely.

The foregoing descriptions are merely preferred embodiments of the present invention, and are not used to limit the protection scope of the present disclosure. The embodiments disclosed herein are exemplary only. Other applications, advantages, alternations, modifications, or equivalents to the disclosed embodiments are obvious to those skilled in the art and are intended to be encompassed within the scope of the present disclosure.

What is claimed is:

1. A method for updating IP geographic information, comprising:
determining initial geographic information of a new IP according to a user log, and establishing an initial geographic information table of all new IPs;
performing a segment aggregation processing on the initial geographic information table to obtain a segment IP geographic information table;
performing a boundary demarcation processing on the segment IP geographic information table to obtain an accurate geographic information table of the new IPs; and
updating an IP library according to the accurate geographic information table of the new IPs.

2. The updating method according to claim 1, wherein the step of determining the initial geographic information of the new IP according to the user log, and establishing the initial geographic information table of all new IPs comprises:
determining the new IP,
establishing a correspondence relationship between the new IP and a user,
obtaining, according to the user log, a city that the user logs in most frequently,
aggregating, by using an IP as a unit, the city that the user logs in most frequently, wherein a log-in city of a greatest aggregation degree is the initial geographic information of the new IP, and
counting initial geographic information of all new IPs into the initial geographic information table.

3. The updating method according to claim 2, wherein the step of obtaining, according to the user log, the city that the user logs in most frequently comprises:
counting, in the user log, a city corresponding to an IP that has been logged in and used by the user, and
determining, within a preset time limit, the city that the user logs in most frequently.

4. The updating method according to claim 1, wherein the step of performing the segment aggregation processing on the initial geographic information table to obtain the segment IP geographic information table comprises:
segmenting, by using a K-means algorithm, initial geographic information of the new IPs in the initial geographic information table;
computing a geographic information aggregation degree of each segment IP after segmentation;
selecting, for each segment IP, geographic information having a greatest aggregation degree higher than a threshold P0 and having a number of occurrences higher than a threshold NO as geographic information of the segment IP; and
counting the geographic information of each segment IP into the segment IP geographic information table.

5. The updating method according to claim 4, wherein the method further comprises:
linking adjacent segment IPs having consistent geographic information to form a new segment IP having geographic information, and
counting the geographic information of the new segment IP into the segment IP geographic information table directly; and
determining geographic information of a segment IP, whose geographic information cannot be determined by using a geographic information aggregation degree, according to a front segment IP and a rear segment IP of the segment IP that have consistent geographic information.

6. The updating method according to claim 1, wherein the step of performing the boundary demarcation process on the segment IP geographic information table to obtain the accurate geographic information table of the new IPs comprises:
searching segment IPs in the segment IP geographic information table inward for a boundary, and
searching, after searching inward for the boundary, the segment IPs in the segment IP geographic information table outward for a boundary, to generate the accurate geographic information table of the new IPs.

7. The updating method according to claim 1, wherein the step of updating the IP library according to the accurate geographic information table of the new IPs comprises:
converting the accurate geographic information table of the new IPs into an IP library standard interface;
computing an adoption credit score of each new IP in the accurate geographic information table of the new IPs; and
connecting the accurate geographic information table of the new IPs into IP library processing logic, to participate in a daily update processing of the IP library.

8. An apparatus for updating IP geographic information, comprising:
an initial information determining module; an adoption processing module; a boundary searching module; and an updating module,
the initial information determining module being configured to determine initial geographic information of a new IP according to a user log, and establish an initial geographic information table of all new IPs,
the adoption processing module being configured to perform a segment aggregation processing on the initial geographic information table established by the initial information determining module, to obtain a segment IP geographic information table,
the boundary searching module being configured to perform a boundary demarcation processing on the segment IP geographic information table to obtain an accurate geographic information table of the new IPs, and
the updating module being configured to update an IP library according to the accurate geographic information table of the new IPs.

9. The updating apparatus according to claim 8, wherein the adoption processing module is configured: to segment, by using a K-means algorithm, initial geographic information of the new IPs in the initial geographic information table; to compute a geographic information aggregation degree of each segment IP after segmentation; to select, for each segment IP, geographic information having a greatest aggregation degree higher than a threshold P0 and having a number of occurrences higher than a threshold NO as geographic information of the segment IP; and to count the geographic information of each segment IP into the segment IP geographic information table.

10. The updating apparatus according to claim 9, wherein the adoption processing module is further configured: to link adjacent segment IPs having consistent geographic information to form a new segment IP having geographic information, and to count the geographic information of the new segment IP into the segment IP geographic information table directly; and to determine geographic information of a segment IP whose geographic information cannot be determined by using a geographic information aggregation degree, according to a front segment IP and a rear segment IP of the segment IP that have consistent geographic information.

11. The updating apparatus according to claim 8, wherein the initial information determining module is configured: to determine the new IP, to establish a correspondence relationship between the new IP and a user, to obtain, according to the user log, a city that the user logs in most frequently, to aggregate, by using an IP as a unit, the city that the user logs in most frequently, wherein a log-in city of a greatest aggregation degree is the initial geographic information of the new IP, and to count initial geographic information of all new IPs into the initial geographic information table.

12. The updating apparatus according to claim 11, wherein the initial information determining module is further configured: to count, in the user log, a city corresponding to an IP that has been logged in and used by the user, and to determine, within a preset time limit, the city that the user logs in most frequently.

13. The updating apparatus according to claim 8, wherein the boundary searching module is configured: to search segment IPs in the segment IP geographic information table inward for a boundary, and to search, after searching inward for the boundary, the segment IPs in the segment IP geographic information table outward for a boundary to generate the accurate geographic information table of the new IPs.

14. The updating apparatus according to claim 8, wherein the updating module is configured: to convert the accurate geographic information table of the new IPs into an IP library standard interface; to compute an adoption credit score of each new IP in the accurate geographic information table of the new IPs; and to connect the accurate geographic information table of the new IPs into IP library processing logic, to participate in a daily update processing of the IP library.
